(19) United States
(12) Patent Application Publication
(10) Pub. No.: US 2020/0241911 A1
(43) Pub. Date: Jul. 30, 2020

(54) AUTOMATICALLY FREEING UP VIRTUAL MACHINE RESOURCES BASED ON VIRTUAL MACHINE TAGGING

(71) Applicant: Hewlett Packard Enterprise Development LP, Houston, TX (US)

(72) Inventor: Shrinath Vasudevamurthy Honnavalli, Bangalore Karnataka (IN)

(21) Appl. No.: 16/520,314

(22) Filed: Jul. 23, 2019

(30) Foreign Application Priority Data
Jan. 29, 2019 (IN) 201941003551

(51) Int. Cl. G06F 9/455; G06F 9/50

(52) U.S. Cl. CPC G06F 9/45558; G06F 2009/4557; G06F 9/505

(57) ABSTRACT

In some examples, a method includes receiving a usage-level tag for a Virtual Machine (VM); determining whether an enterprise scaling criteria is met; and in response to a determination that the scaling criteria is met and in response to the VM being tagged with a certain usage-level tag: automatically performing a snapshot operation on the VM, and automatically freeing up resources on the snapshotted VM.

### BACKGROUND

The term “Virtual Machine” (VM), can for example, refer broadly to an emulation of a computer system, device, or functionality thereof. VMs can be based on computer architectures and provide functionality of one or more physical computers. VM implementations may involve specialized hardware, software, or a combination thereof. In some environments, a VM may be used to support separate operating systems (OS's), such as a system that executes a real-time OS simultaneously with a preferred complex OS. In some implementations, a process VM, sometimes called an application virtual machine, or Managed Runtime Environment (MRE), can run as a normal application inside a host OS and supports a single process. It can, for example, be created when a process is started and destroyed when it exits. Such an environment can be used to provide a platform-independent programming environment that abstracts away details of the underlying hardware or OS and allows a program to execute in the same way on any platform.

### BRIEF DESCRIPTION OF DRAWINGS

FIG. 1 is a flowchart for a method, according to an example.

FIG. 2 is a flowchart for a method, according to another example.

FIG. 3 is a flowchart for a method, according to another example.

FIG. 4 is a diagram of a computing device, according to an example.

FIG. 5 is a diagram of machine-readable storage medium, according to an example.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

It is appreciated that a VM can be used for a variety of purposes. Some VMs are used sparsely yet lock up a significant amount of compute/storage/networking resources. When such a VM is running on a private cloud, the VMs can hog resources even when not in use. Cloud administrators do not have a simple mechanism to shutdown such VMs and stop such unnecessary usage. Certain implementations of the present disclosure are directed to a mechanism to tag and decide the running of VMs based on the critical nature of their usage. In some implementations, a method can, for example, include: (1) receiving a usage-level tag for a VM; (2) determining whether an enterprise scaling criteria is met; and (3) in response to a determination that the scaling criteria is met and in response to the VM being tagged with a certain usage-level tag: automatically performing a snapshot operation on the VM, and automatically freeing up resources on the snapshotted VM. Certain implementations of the present disclosure can, for example, be used to help an enterprise keep the cost low and reduce the need to burst into the costly public cloud space. Other advantages of implementations presented herein will be apparent upon review of the description and figures.

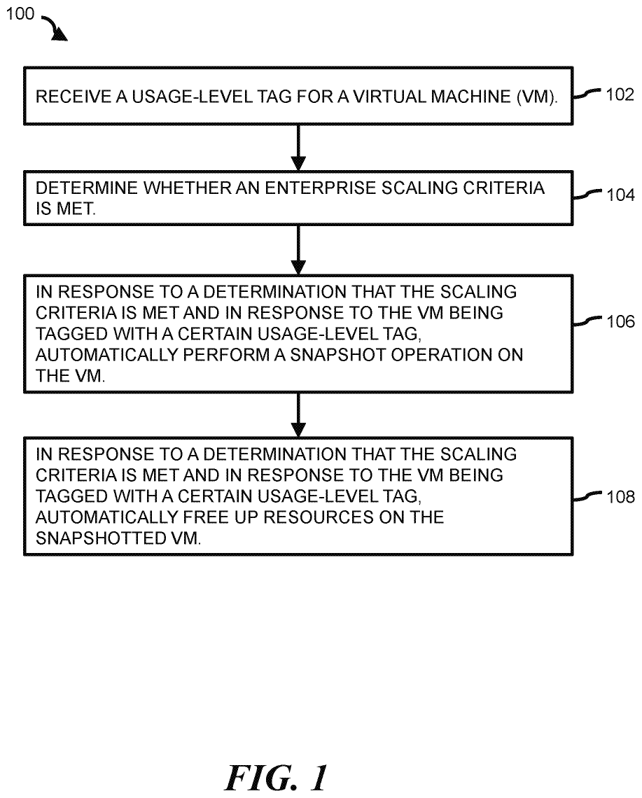

FIG. 1 depicts a flowchart for an example method 100 related to automatically freeing up VM resources based on VM tagging. It is appreciated that VMs are a popular mechanism for deploying public and private cloud computing application infrastructure. In some implementations, multiple instances of a VM can share the same physical hardware and each application VM can have its own set of OS, networking and storage. The present disclosure refers to the use of VMs throughout, however it is appreciated that the term VM can be broadly construed to include various suitable virtualization techniques, such as virtualized containers. For example, in some implementations, a VM can be in the form of a virtualized container. As used herein, the term “container” can, for example, refer to operating-system-level virtualization in which a kernel or other mechanism allows for multiple isolated user-space instances. Such instances can, for example, be referred to as containers, partitions, virtualization engines (“VEs”), jails, or another suitable term. Such instances can, for example, be designed to look like real computers from the point of view of programs running in them. In comparison to a conventional computer program, which may have visibility of all resources (e.g., connected devices, files and folders, network shares, CPU power, quantifiable hardware capabilities) of the computer running the program, programs running inside a container can be designed to have visibility limited to the container's contents and specific devices assigned to the container. Such containers can, in some implementations, include additional isolation mechanisms that can provide resource-management features to limit the impact of one container's activities on other containers.

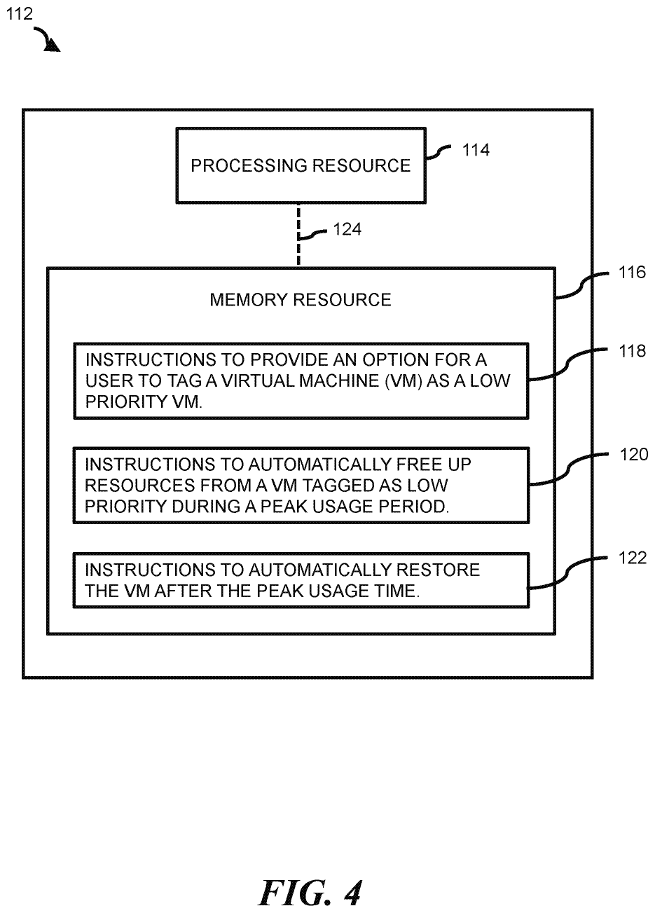

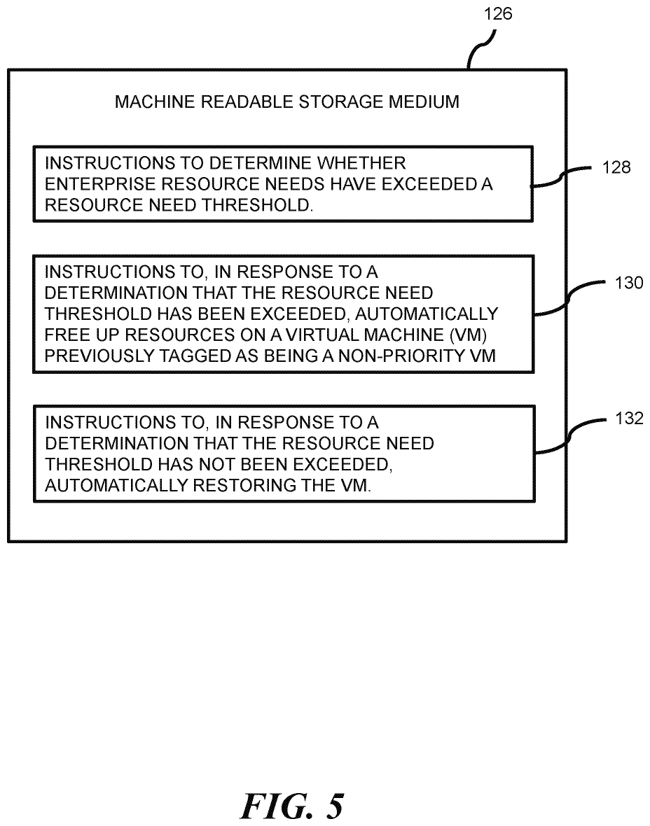

In some implementations, method 100 can be implemented or otherwise executed through the use of executable instructions stored on a memory resource (e.g., the memory resource of the computing device of FIG. 4), executable machine readable instructions stored on a storage medium (e.g., the medium of FIG. 5), in the form of electronic circuitry (e.g., on an Application-Specific Integrated Circuit (ASIC)), and/or another suitable form. Although the description of method 100 herein primarily refers to steps performed on a server for purposes of illustration, it is appreciated that in some implementations, method 100 can be executed on another computing device within a data center or in communication therewith. In some implementations, method 100 can be executed on multiple devices in parallel (e.g., in a distributed computing fashion).

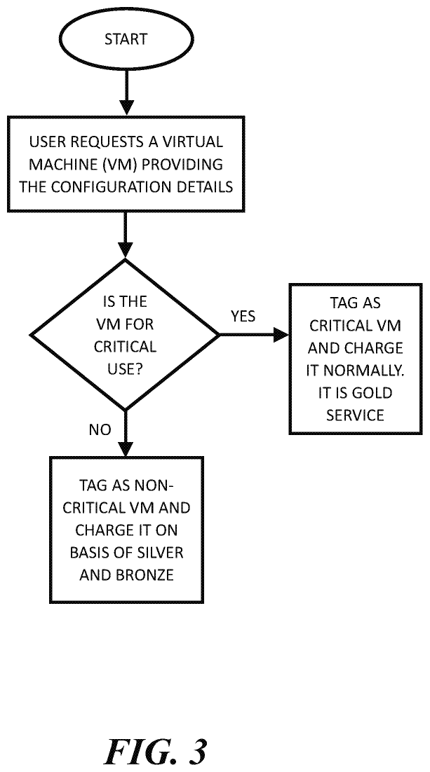

Method 100 includes receiving (at block 102) a usage-level tag for a VM. In some implementations, the usage-level tag indicates that the VM is classified as one of a critical, important, or experimental VM. It is appreciated that different usage-levels may be used as appropriate or desired by an enterprise. For example, in some implementations, the usage-level tag can merely indicate whether the VM is classified as a non-priority VM. As another example (and as depicted in the flow chart of FIG. 3), the system may provide levels of service to a customer including “gold”, “silver”, and “bronze”-level service, one or more of which may be associated with reduced billing costs by an infrastructure provider.

Method 100 includes determining (at block 104) whether an enterprise scaling criteria is met. Such a scaling criteria can, for example, be related to enterprise VM resource needs, such as server, storage, and networking needs. Such VM resource needs can be based on monitored needs at a current time or can be based on predicted needs at the current time or at one or more future times. For based, in some implementations, enterprise VM resource needs can be predicted based on historical resource needs. Such historical resource needs can, for example, be based on day of the week (e.g., Monday vs. Tuesday, weekday vs. weekend, etc.), time of day (e.g., 9 am local time vs. 1 pm local time, morning vs. evening, etc.), day of the year (e.g., 1^{st} of the month vs. 15^{th} of the month, etc.). It is appreciated that in some implementations, predictions can be based on one or more aspects of historical data, such as predictions based on both day of the week and time of day (e.g., Monday mornings).

Method 100 includes, in response to a determination that the scaling criteria is met and in response to the VM being tagged with a certain usage-level tag, automatically performing (at block 106) a snapshot operation on the VM. Such a snapshot operation can, for example, create a copy of VMs disk file at a given point in time. Such a snapshot may provide a change log for the virtual disk and can, for example, be used to restore a VM to a particular point in time. In some implementations, a snapshot can, for example, capture an entire state of a VM at the time the snapshot is taken. Such a snapshot can, for example, include contents of the VM's memory, VM settings, and state of all the VM's virtual disks.

Method 100 includes, in response to a determination that the scaling criteria is met and in response to the VM being tagged with a certain usage-level tag, automatically freeing up (at block 108) resources on the snapshotted VM. Block 108 can, for example, include shutting down, turning off, and/or suspending one or more snapshotted VMs. It is appreciated that any suitable technique for safely freeing up resources from the snapshotted may be used. For example, in some implementations, block 108 includes performing a graceful shutdown of the snapshotted VM. In some implementations, method 100 can include automatically allocating any freed up resources from the snapshotted VM to another VM to assist with satisfying enterprise resource needs.

It is appreciated that one or more operations of method 100 can be performed periodically. For example, in some implementations, one or more of blocks 102, 104, 106, and 108 (or other operations described herein) may be performed periodically. The various period times for blocks 102, 104, 106, and 108 (or other operations described herein) may be the same or different times. For example, in some implementations, the period of block 102 is every 1 minute and the period of block 104 is every 2 minutes. It is further appreciated, that the period for a given block may be regular (e.g., every 1 minute) or may be irregular (e.g., every 1 minute during a first condition, and every 2 minutes during a second condition). In some implementations, one or more of block 102, 104, and 106 (or other operations described herein) may be non-periodic and may be triggered by some network or other event.

Although the flowchart of FIG. 1 shows a specific order of performance, it is appreciated that this order may be rearranged into another suitable order, may be executed concurrently or with partial concurrence, or a combination thereof. Likewise, suitable additional and/or comparable steps may be added to method 100 or other methods described herein in order to achieve the same or comparable functionality. In some implementations, one or more steps are omitted. For example, in some implementations, block 108 of automatically freeing up resources can be omitted from method 100 or performed by a different device or performed manually by an administrator. It is appreciated that blocks corresponding to additional or alternative functionality of other implementations described herein can be incorporated in method 100. For example, blocks corresponding to the functionality of various aspects of implementations otherwise described herein can be incorporated in method 100 even if such functionality is not explicitly characterized herein as a block in method 100.

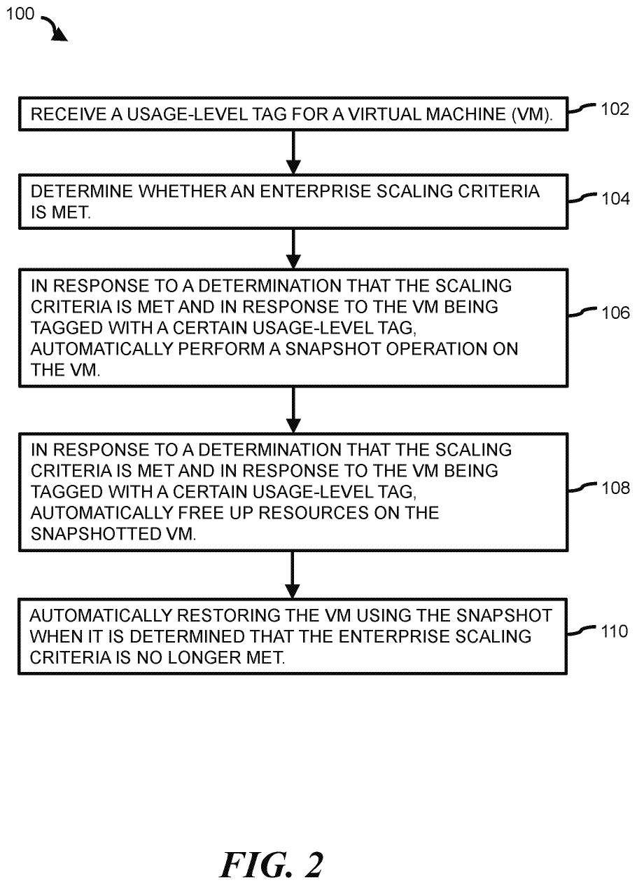

FIG. 2 illustrates another example of method 100 in accordance with the present disclosure. It is appreciated that method 100 of FIG. 2 can incorporate one or more aspects of method 100 of FIG. 1 and vice versa. For example, in some implementations, method 100 of FIG. 1 can include the additional step described below with respect to method 100 of FIG. 2. Method 100 of FIG. 2 includes automatically restoring (at block 110) the VM using the snapshot when it is determined that the enterprise scaling criteria is no longer met. For example, it may be determined that enterprise scaling criteria is no longer met because there is no longer a need for additional VMs to satisfy enterprise VM resource needs.

Various example implementations for the present disclosure will now be described. It is appreciated that these examples may include or refer to certain aspects of other implementations described herein (and vice-versa), but are not intended to be limiting towards other implementations described herein. Moreover, it is appreciated that certain aspects of these implementations may be applied to other implementations described herein.

As provided above, users can use VMs for a variety of purposes. Some VMs can be used sparsely yet still lock up a significant amount of compute/storage/networking resources. When VMs are running on a private cloud, these VMs can hog resources even when not in use. Administrators currently do not have an easy mechanism to shutdown/stop this usage. Certain implementations of the present disclosure are directed to providing a mechanism to tag VMs when a user requests a resource (either during an initial provisioning or setup stage or at another time). An infrastructure provider or administrator can offer such a VM at a lower cost to encourage users to tag their VMs at an optimal usage level (e.g., critical, important, experimental, etc.) When the enterprise requires more compute/storage resources (during a holiday sale, etc.), the cloud management software can look for resources that are tagged as experimental and proceed automatically (or through user intervention) to snapshot the VM and free up the resources. Such a system can, for example, be used to help the enterprise keep the cost low and reduce the need to burst into the costly public cloud space.

As shown in FIG. 3, one implementation of the present disclosure can, for example, provide “bronze”, “silver”, and “gold” service levels (and corresponding VM pricing structures). Such a “bronze”-level service may signify that the VM is not for critical purposes and when the enterprise is to reclaim the resources, a user can, for example, be notified two hours (or another suitable time period) in advance and will proceed with stopping the VM with no additional consent required. The resources will be returned once the requirement is complete and user will be notified. Such a “silver service” may signify that the VM is not for critical purposes and when the enterprise requires to reclaim the resources, the user will be notified and when the user approves it, the VM will be stopped (snapshot taken). When the resources can be returned, the VM will be resumed and user notified. Such a “gold”-level service, may correspond to a traditional “critical” VM service level, and may be charged normally.

As used herein, the term “cloud” can, for example refer to a group of networked elements providing services that are not necessarily individually addressed or managed by users. Instead, an entire provider-managed suite of hardware and software can be thought of as an amorphous “cloud.” Cloud computing can, for example, refer to an IT paradigm that enables ubiquitous access to shared pools of configurable system resources and higher-level services that can be rapidly provisioned with minimal management effort, often over the Internet. The term “private cloud” as used herein can, for example, refer to a cloud in which cloud infrastructure is operated solely for a single organization, whether managed internally or by a third-party, and hosted either internally or externally. The term “public cloud” as used herein can, for example, refer to a cloud in which services are rendered over a network that is open for public use and accessed generally via the Internet. The term “hybrid cloud” as used herein can, for example, refer to a cloud computing service that is composed of some combination of private, public and community cloud services, from different service providers. Varied use cases for hybrid cloud composition exist. For example, an organization may choose to store sensitive client data locally on a private cloud application and infrastructure, but may choose to interconnect that application to a business intelligence application provided on a public cloud as a software service.

In private cloud, the costing of VM is an important topic, and there is interest from administrators regarding efficient ways of cost calculation based on power usage, utilization, storage, etc. It is appreciated that enterprises often have difficulty justifying the cost of setting up infrastructure in-house and further face challenges scaling infrastructure on a needed basis. Certain implementations of the present disclosure allow users to tag VMs at one or more levels and administrators can stop/suspend certain VMs to free up resources for their peak needs (such as during a “flash sale” or during a holiday (e.g., black Friday) sale, etc.). By incentivizing the users to do this kind of tagging (where a VM can be stopped based on a tag), this may enable discounted pricing for low-priority VMs and the efficiency of a user's private cloud may be significantly enhanced.

It is appreciated that such priority tagging may be used with other suitable automation triggers and events. For example, in some implementations, the system may rely on such tags to schedule starting and stopping of VMs by linking to enterprise calendaring tools. For example, it is appreciated that a user can create and maintain VMs on private or public cloud as per their needs. However, many VM instances are not required to be running when the user is not physically logged in or using the resources. In these instances, currently user can provide a schedule of when to stop and resume the VMs there by reducing the billing cost.

Such an implementation can provide a way for users to link VMs by tagging or otherwise linking a scheduling algorithm to an enterprise calendar and leave management tool. For example, in a situation where a user is scheduled to take a leave of absence based on data from a leave management tool, the system can automatically inform the cloud management software to snapshot the VM and resume once the user is back from vacation. Similarly, the cloud management software can incorporate an ability to stop and resume the resources on enterprise declared holidays. This mechanism can provide improved efficiency compared to manual employee entry, which may reduce billing costs by up to 10-15% or more. In some implementations, the system can link with an employee's calendaring and leave management tool to automatically cloud management software to snapshot a VM and resume once the user is back from vacation. Further, the cloud management software can incorporate an ability to stop and resume the resources on enterprise declared holidays.

FIG. 4 is a diagram of a computing device 112 in accordance with the present disclosure. Computing device 112 can, for example, be in the form of one or more servers executing a data center infrastructure management system, or another suitable computing device within a data center or in communication with a data center or equipment thereof. As described in further detail below, computing device 112 includes a processing resource 114 and a memory resource 116 that stores machine-readable instructions 118, 120, and 122. For illustration, the description of computing device 112 makes reference to various aspects of the diagrams of FIGS. 1-3. However it is appreciated that computing device 112 can include additional, alternative, or fewer aspects, functionality, etc., than the implementations described elsewhere herein and is not intended to be limited by the related disclosure thereof.

Instructions 118 stored on memory resource 116 are, when executed by processing resource 114, to cause processing resource 114 to provide an option for a user to tag a VM as a low priority VM. Instructions 118 can incorporate one or more aspects of blocks of method 100 or another suitable aspect of other implementations described herein (and vice versa).

Instructions 120 stored on memory resource 116 are, when executed by processing resource 114, to cause processing resource 114 to automatically free up resources from a VM tagged as low priority during a peak usage period. Instructions 120 can incorporate one or more aspects of blocks of method 100 or another suitable aspect of other implementations described herein (and vice versa). For example, in some implementations, instructions 120 are to cause the processing resource to automatically free up resources from multiple VMs tagged as low priority to meet a need for resources during the peak usage period. In some implementations, the peak usage period is predicted based on historical peak usage periods.

Instructions 122 stored on memory resource 116 are, when executed by processing resource 114, to cause processing resource 114 to automatically restore the VM after the peak usage period. Instructions 122 can incorporate one or more aspects of blocks of method 100 or another suitable aspect of other implementations described herein (and vice versa). For example, in some implementations, the system provides reduced pricing for VMs tagged as low priority.

Processing resource 114 of computing device 112 can, for example, be in the form of a central processing unit (CPU), a semiconductor-based microprocessor, a digital signal processor (DSP) such as a digital image processing unit, other hardware devices or processing elements suitable to retrieve and execute instructions stored in memory resource 116, or suitable combinations thereof. Processing resource 114 can, for example, include single or multiple cores on a chip, multiple cores across multiple chips, multiple cores across multiple devices, or suitable combinations thereof. Processing resource 114 can be functional to fetch, decode, and execute instructions as described herein. As an alternative or in addition to retrieving and executing instructions, processing resource 114 can, for example, include at least one integrated circuit (IC), other control logic, other electronic circuits, or suitable combination thereof that include a number of electronic components for performing the functionality of instructions stored on memory resource 116. The term “logic” can, in some implementations, be an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Processing resource 114 can, for example, be implemented across multiple processing units and instructions may be implemented by different processing units in different areas of computing device 112.

Memory resource 116 of computing device 112 can, for example, be in the form of a non-transitory machine-readable storage medium, such as a suitable electronic, magnetic, optical, or other physical storage apparatus to contain or store information such as machine-readable instructions 118, 120, and 122. Such instructions can be operative to perform one or more functions described herein, such as those described herein with respect to method 100 or other methods described herein. Memory resource 116 can, for example, be housed within the same housing as processing resource 114 for computing device 112, such as within a computing tower case for computing device 112 (in implementations where computing device 112 is housed within a computing tower case). In some implementations, memory resource 116 and processing resource 114 are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, memory resource 116 can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

Memory resource 116 can be in communication with processing resource 114 via a communication link 124. Each communication link 124 can be local or remote to a machine (e.g., a computing device) associated with processing resource 114. Examples of a local communication link 124 can include an electronic bus internal to a machine (e.g., a computing device) where memory resource 116 is one of volatile, non-volatile, fixed, and/or removable storage medium in communication with processing resource 114 via the electronic bus.

In some implementations, one or more aspects of computing device 112 can be in the form of functional modules that can, for example, be operative to execute one or more processes of instructions 118, 120, or 122 or other functions described herein relating to other implementations of the disclosure. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of computing device 112 can, for example, include one or more machine-readable storage mediums and one or more computer processors.

In view of the above, it is appreciated that the various instructions of computing device 112 described above can correspond to separate and/or combined functional modules. For example, instructions 118 can correspond to a “VM tagging module” to provide an option for a user to tag a Virtual Machine (VM) as a low priority VM. Likewise, instructions 122 can correspond to a VM restoration module to automatically restore a VM after a peak usage period. It is further appreciated that a given module can be used for multiple functions. As but one example, in some implementations, a single module can be used to both automatically free up resources from a VM tagged as low priority during a peak usage period (e.g., corresponding to the functionality of instructions 120) as well as to automatically restore a VM after the peak usage period (e.g., corresponding to the functionality of instructions 122).

One or more nodes within a data center can further include a suitable communication module to allow networked communication between network equipment. Such a communication module can, for example, include a network interface controller having an Ethernet port and/or a Fibre Channel port. In some implementations, such a communication module can include wired or wireless communication interface, and can, in some implementations, provide for virtual network ports. In some implementations, such a communication module includes hardware in the form of a hard drive, related firmware, and other software for allowing the hard drive to operatively communicate with other hardware. The communication module can, for example, include machine-readable instructions for use with communication the communication module, such as firmware for implementing physical or virtual network ports.

FIG. 5 illustrates a machine-readable storage medium 126 including various instructions that can be executed by a computer processor or other processing resource. In some implementations, medium 126 can be housed within a server or other computing device For illustration, the description of machine-readable storage medium 126 provided herein makes reference to various aspects of computing device 112 (e.g., processing resource 114) and other implementations of the disclosure (e.g., method 100). Although one or more aspects of computing device 112 (as well as instructions such as instructions 118, 120, and 122) can be applied to or otherwise incorporated with medium 126, it is appreciated that in some implementations, medium 126 may be stored or housed separately from such a system. For example, in some implementations, medium 126 can be in the form of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof.

Medium 126 includes machine-readable instructions 128 stored thereon to cause processing resource 114 to determine whether enterprise resource needs have exceeded a resource need threshold. Instructions 128 can, for example, incorporate one or more aspects of block 102 of method 100 or another suitable aspect of other implementations described herein (and vice versa). For example, in some implementations, the resource need threshold is based on a combination or compute and storage resources.

Medium 126 includes machine-readable instructions 130 stored thereon to cause processing resource 114 to, in response to a determination that the resource need threshold has been exceeded, automatically free up resources on a VM previously tagged as being a non-priority VM. Instructions 130 can, for example, incorporate one or more aspects of block 104 of method 100 or another suitable aspect of other implementations described herein (and vice versa). For example, in some implementations, the freed up resources are allocated to assist with meeting the enterprise resource needs.

Medium 126 includes machine-readable instructions 132 stored thereon to cause processing resource 114 to, in response to a determination that the resource need threshold has not been exceeded, automatically restore the VM. Instructions 132 can, for example, incorporate one or more aspects of method 100 or another suitable aspect of other implementations described herein (and vice versa). For example, in some implementations, the VM is restored using a snapshot of the VM captured before freeing up the VM resources. In some implementations, as a result of a user tagging a VM as a non-priority VM, charging the user a lower price compared to a VM that is not tagged as a non-priority VM.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

What is claimed is:

1. A method comprising:
receiving a usage-level tag for a Virtual Machine (VM);
determining whether an enterprise scaling criteria is met; and
in response to a determination that the scaling criteria is met and in response to the VM being tagged with a certain usage-level tag:
automatically performing a snapshot operation on the VM, and
automatically freeing up resources on the snapshotted VM.

2. The method of claim 1, further comprising:
automatically restoring the VM using the snapshot when it is determined that the enterprise scaling criteria is no longer met.

3. The method of claim 1, wherein the usage-level tag indicates that the VM is classified as one of a critical, important, or experimental VM.

4. The method of claim 1, wherein the usage-level tag indicates that the VM is classified as a non-priority VM.

5. The method of claim 1, wherein the scaling criteria is criteria related to enterprise VM resource needs.

6. The method of claim 5, wherein the enterprise VM resource needs are predicted based on historical resource needs.

7. The method of claim 1, wherein the historical resource needs are based on day of the week.

8. The method of claim 1, wherein the historical resource needs are based on time of day.

9. The method of claim 1, wherein the historical resource needs are based on day of the year.

10. The method of claim 1, wherein the VM is in the form of a virtualized container.

11. The method of claim 1, wherein the freed up resources are allocated to another VM.

12. A non-transitory machine readable storage medium having stored thereon machine readable instructions to cause a computer processor to:
determine whether enterprise resource needs have exceeded a resource need threshold; and
in response to a determination that the resource need threshold has been exceeded, automatically free up resources on a Virtual Machine (VM) previously tagged as being a non-priority VM; and
in response to a determination that the resource need threshold has not been exceeded, automatically restore the VM.

13. The medium of claim 12, wherein the VM is restored using a snapshot of the VM captured before freeing up the VM resources.

14. The medium of claim 12, wherein as a result of a user tagging a VM as a non-priority VM, charging the user a lower price compared to a VM that is not tagged as a non-priority VM.

15. The medium of claim 12, wherein the resource need threshold is based on a combination or compute and storage resources.

16. The medium of claim 12, wherein the freed up resources are allocated to assist with meeting the enterprise resource needs.

17. A data center infrastructure management system comprising:
a processing resource; and
a memory resource storing machine readable instructions to cause the processing resource to:
provide an option for a user to tag a Virtual Machine (VM) as a low priority VM;
automatically free up resources from a VM tagged as low priority during a peak usage period; and
automatically restore the VM after the peak usage period.

18. The system of claim 14, wherein the instructions are to cause the processing resource to automatically free up resources from multiple VMs tagged as low priority to meet a need for resources during the peak usage period.

19. The system of claim 14, wherein the peak usage period is predicted based on historical peak usage periods.

20. The system of claim 14, wherein the system provides reduced pricing for VMs tagged as low priority.
